(19) United States
(12) Patent Application Publication
(10) Pub. No.: US 2015/0163490 A1
(43) Pub. Date: Jun. 11, 2015

(54) PROCESSING METHOD AND SYSTEM FOR GENERATING AT LEAST TWO COMPRESSED VIDEO STREAMS

(71) Applicant: ATEME, Bievres (FR)

(72) Inventor: Pierre Larbier, Bievres (FR)

(21) Appl. No.: 14/401,985

(22) PCT Filed: May 16, 2013
(86) PCT No.: PCT/FR2013/051072

§ 371 Date: Nov. 18, 2014

(30) Foreign Application Priority Data
May 18, 2012 (FR) 1254567

(51) Int. Cl. H04N 19/136; H04L 29/06; H04N 19/147; H04N 19/85

(52) U.S. Cl. CPC H04N 19/136; H04N 19/85; H04L 65/602; H04L 65/80; H04N 19/147

(57) ABSTRACT

The subject matter of the present invention relates to a method and a computing device (100) for processing a video stream (IN) that makes it possible to generate at least two compressed video streams (OUT1 and OUT2), the device according to the present invention comprising:—an analysis means (M1) configured to analyse at least one image (I) of the video stream (IN) in order to determine at least one metric of said video stream (IN), and -at least first (M5_{—}1) and second (M5_{—}2) encoding means configured to encode, on the basis of said at least one metric, said video stream previously decimated spatially and/or temporally so as to obtain said at least two compressed video streams (OUT1, OUT2).

### TECHNICAL FIELD

The object of the present invention relates to the field of digital video encoding/decoding, and more specifically the compression/decompression of digital video streams.

The object of the present invention relates to specific data processing which generates multiple and independent compressed video streams from the same source video.

The object of the invention thus has particularly advantageous applications for multi-stream video encoders by allowing the distribution of multimedia content over the Internet or mobile networks based on adaptive bitrate streaming technologies such as HLS (“HTTP Live Streaming”), “SmoothStreaming”, or MPEG DASH (for “Dynamic Adaptive Streaming over HTTP”).

### STATE OF THE ART

Currently, methods for the distribution of multimedia content via the Internet or mobile networks are based on adaptive bitrate streaming technologies.

With such methods, the receiver chooses the bitrate at which it wishes to receive content.

Also, whether produced as a live television program or pre-recorded as a video clip, the desired content is compressed simultaneously and independently at different bitrates.

To do this, the receiver, which is informed of the compressed streams available, continuously measures the transmission rate available on the connection, and requests from the content server the version having the bitrate most suitable for the connection.

It is understood here that there are numerous conditions affecting the selection.

This generally involves selecting the stream having a bitrate just under the capacity of the connection.

However, other aspects may guide the selection: these may, for example, include the decoding capacity of the receiver, the startup time for decoding for new content, or rights management.

In practice, ten or so streams are provided by the server for a given type of receiver; the bitrate selection is made by the receiver every ten seconds.

Multiple techniques are currently available. However, the two main methods explained below cover almost all current deployments.

First there is the HLS method (for “HTTP Live Streaming”), proposed by Apple® and implemented on all devices of this brand.

The concept upon which this method is based concerns dividing the streams into ten-second chunks.

With this method, each chunk contains a video stream compressed using the H.264/AVC standard and an audio stream compressed using the MPEG AAC standard. These two streams are encapsulated in an MPEG transport stream layer.

There is also the method called “SmoothStreaming”, proposed by Microsoft®.

This method is substantially similar to the HLS method described above, except that it is based on the encapsulation of chunks in MPEG-4 files.

This difference offers the advantage of allowing the transmission of ancillary data such as subtitles, and allows simple direct access to inside the chunks (called “seeks”).

In any case, the plurality of transmission techniques and the wide variations in receiver capacities makes it necessary to encode a large number of versions of the same sources.

It is therefore generally necessary to produce dozens of versions of the same content simultaneously.

In the field of video, the main variations are: the compressed bitrate, the dimensions of the compressed images, the number of frames per second (the frame rate), or the profile of the standard used.

To generate as many video streams as necessary, one must design a multi-stream video transcoder where the structure consists of having as many encoders working in parallel as there are variations to be produced.

The applicant submits that there are drawbacks to such a structure.

On the one hand, the plurality of independent encoders is very inefficient in terms of the amount of computation to be carried out. One will note that with such a system, the same source is processed multiple times with only slight variations.

On the other hand, the output streams are divided into chunks. For the receiver to be able to switch from one stream to another, these chunks must be aligned; in other words, the same source image must be encoded at the beginning of each chunk.

As the encoders are independent, the most practical and reliable method to ensure this alignment is to impose which source images constitute the boundaries of the chunk, regardless of their content. The consequence of this technique is the inability to take into account the images that constitute a change of scene.

### PURPOSE AND SUMMARY OF THE INVENTION

One objective of the invention is to improve the situation described above.

For this purpose, the object of the invention is a method for processing a video stream that allows generating at least two compressed video streams.

According to the invention, the processing method includes an analysis step in which at least one image of the video stream is analyzed in order to determine at least one metric of the video stream.

“Metric of a video stream” in the sense of the invention is understood here to mean data containing at least one item of physical information characterizing an image or a sequence of images of the video stream, spatially or spatiotemporally.

The metrics defined in this step include the average brightness, the indication of a scene change, the variance, the complexity, the local and/or overall activity, a pre-grid of weighting information for blocks of images, and/or a set of motion vectors.

Next, the treatment method involves an encoding step in which, following a transformation such as, for example, a spatial and/or temporal decimation, a change of color space, and/or a deinterlacing operation on the video stream, the transformed video stream is encoded in accordance with said at least one metric so as to obtain at least two compressed video streams.

Thus, through this sequence of steps which is a characteristic of the invention, the processing method described above generates a plurality of compressed video streams which are independent of each other, from the same source.

With this analysis, the encoding is inherently multi-stream. In other words, according to the invention, each output video stream is independently decodable, and these streams can share common characteristics as synchronization points.

Advantageously, the processing method according to the invention comprises a first determination step during which an encoding structure for the video stream is determined in accordance with said at least one metric.

The determination of the most appropriate encoding structure from a metric of the video stream allows synchronous partitioning of the stream into chunks.

This allows making use of the temporal and/or spatial structure of the video stream.

Thus, in the case of MPEG-type predictive encoders, this can be the type of image (I, P or B). It is understood here that it can also be a much more discriminating encoding structure, such as the coding mode of each block of the image.

Advantageously, the processing method according to the invention comprises a second determination step during which an adaptive quantization of the video stream is determined in accordance with said at least one metric.

This quantization allows controlling the lossy component of the compression and the bitrate of the output video stream compressed for the network.

This can, for example, consist of a quantization grid in which all pixels of a block must be decimated spatially and/or temporally as a function of a quantization interval.

Advantageously, the processing method according to the invention comprises a processing step consisting in particular of scaling said video stream and/or said at least one metric.

Such scaling permits said at least one metric to match the video stream to be encoded.

According to the invention, the scaling is performed in such a way that it allows a change of spatiotemporal resolution and/or a change of frame rate.

Advantageously, the processing method according to the invention comprises a refinement step during which said at least one metric is refined for at least one image of the digital stream.

Correspondingly, the object of the invention relates to a computer program comprising instructions adapted for executing the steps of the providing method as described above, in particular when said computer program is executed by a computer.

Such a computer program may use any programming language, and be in the form of source code, object code, or an intermediate code between source code and object code such as a partially compiled form, or any other desirable form.

Similarly, the object of the invention relates to a computer-readable storage medium on which is stored a computer program comprising instructions for executing the steps of the providing method as described above.

The storage medium may be any entity or device capable of storing the program. For example, it may comprise a storage means such as ROM memory, for example a CD-ROM or a ROM microelectronic circuitry, or a magnetic storage means, for example a diskette (floppy disk) or hard drive.

Or this storage medium may be a transmission medium such as an electrical or optical signal, such a signal possibly conveyed via an electrical or optical cable, by terrestrial or over-the-air radio, or by self-directed laser beam, or by other means. The computer program according to the invention may in particular be downloaded over a network such as the Internet.

Alternatively, the storage medium may be an integrated circuit in which the computer program is embedded, the integrated circuit being adapted to execute or be used in the execution of the method in question.

The object of the invention also relates to a computing device comprising computing means configured to implement the steps of the method described above.

More specifically, according to the invention, the computing device comprises an analysis means configured for analyzing at least one image of the video stream in order to determine at least one metric of said video stream.

According to the invention, the computing device further comprises at least first and second encoding means configured to encode, in accordance with said at least one metric, said video stream previously transformed in a transformation such as, for example, a spatial and/or temporal decimation, a change of color space, and/or a deinterlacing operation on the video stream.

The first and second encoding means thus allow obtaining, in accordance with said at least one metric, said at least two compressed video streams.

Advantageously, the computing device according to the invention comprises at least one first determination means configured for determining, in accordance with said at least one metric, an encoding structure of the video stream.

Advantageously, the computing device according to the invention comprises at least one second determination means configured for determining, in accordance with said at least one metric, an adaptive quantization of the video stream.

Advantageously, the computing device according to the invention comprises at least one processing means configured to allow scaling the video stream and/or said at least one metric.

According to the invention, said at least one processing means is configured to enable a change of spatiotemporal resolution of the video stream and/or a change of frame rate.

Advantageously, said at least one processing means is further configured for refining said at least one metric for at least one image of the video stream.

Thus, the object of the invention, through its various functional and structural aspects, allows a particularly advantageous multi-stream generation for the distribution of multimedia content via the Internet or mobile networks, based on adaptive bitrate streaming techniques.

### DESCRIPTION OF THE APPENDED FIGURES

Other features and advantages of the invention will become apparent from the following description, with reference to the accompanying FIGS. 1a to 2 which illustrate an exemplary embodiment without any limiting character and in which:
FIGS. 1a and 1b each schematically represent a computing device according to an advantageous embodiment of the invention; and
FIG. 2 represents a flowchart illustrating the processing method according to an advantageous embodiment.

### DETAILED DESCRIPTION OF AN EMBODIMENT OF THE INVENTION

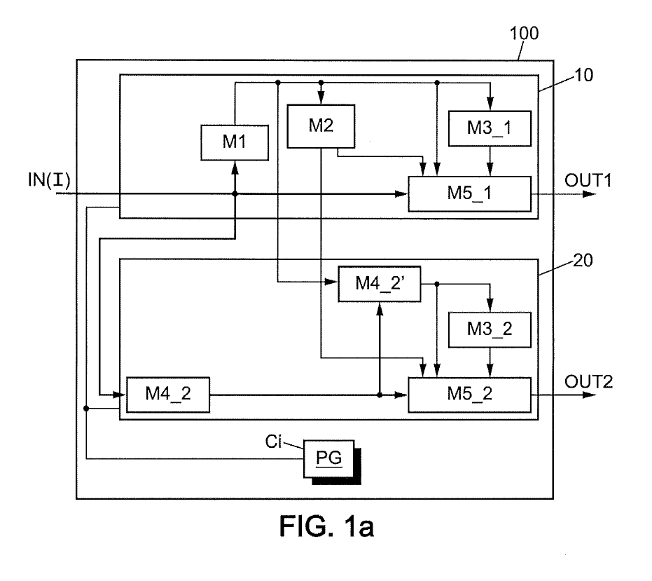

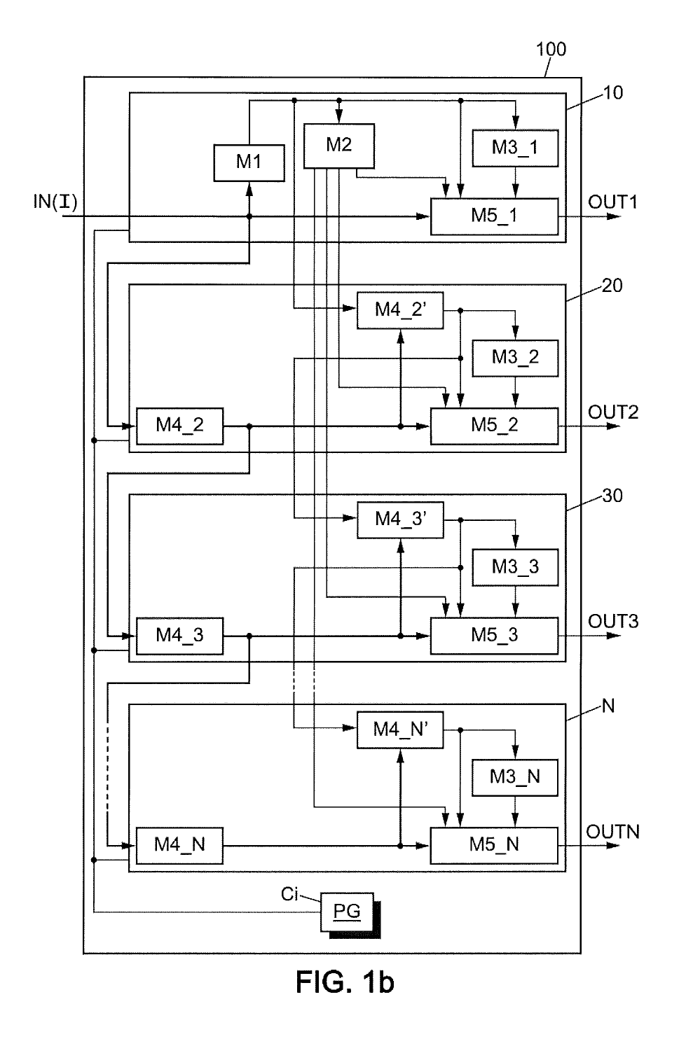

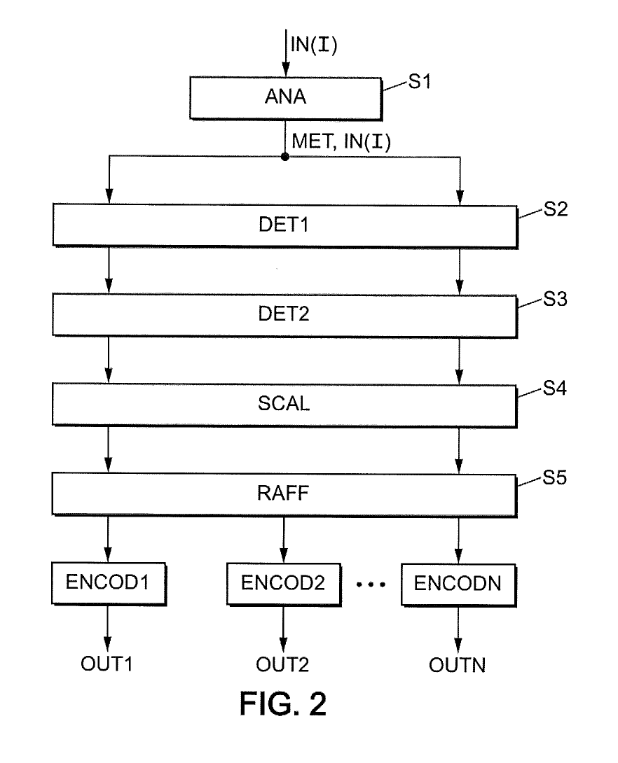

A processing method and the corresponding computing device, according to an advantageous embodiment of the invention, will now be described below with reference to FIGS. 1a to 2.

As a reminder, in a traditional approach a video encoder processes a source video and produces a compressed stream from this source; enabling the design of a multi-stream video encoder from a single source video is one of the aims of this invention.

For this purpose, the object of the invention relates to a computing device 100 configured to implement a processing method as shown in FIG. 2.

More specifically, in the example described here, the computing device 100 according to the invention allows processing an input video stream IN such that a plurality of at least two video streams OUTN (N being an positive integer between 2 and N) is generated.

In the example corresponding to FIG. 1a, two compressed video streams OUT1 and OUT2 are generated as output.

In the example corresponding to FIG. 1b, N compressed video streams OUT1, OUT2, OUT3, OUTN (here N being a positive integer greater than or equal to 4) are generated as output.

In this example, the device 100 comprises a main video encoder 10 that includes an analysis means M1 adapted to analyze the input video stream IN once during a pre-analysis step S1.

This analysis means M1 thus allows determining once and for all at least one metric MET such as, for example, the average brightness, an indication of a scene change, the variance, the complexity, the local and/or overall activity, a pre-grid of weighting information for blocks of images, and/or a set of motion vectors.

This analysis can be quite complex, and in some cases may even consist of completely encoding the images.

The invention typically consists of using the measurements of these metrics MET obtained during this analysis step S1 to simplify the operations to be performed in the encoding phase.

For example, if the analysis phase includes a motion estimation, the vectors determined during this analysis can be used as starting points for a simple refinement during encoding.

The inventive concept underlying the invention is therefore to use the fact that the measurements made during the analysis phase are subsequently used during the encoding phase, possibly with relatively simple modifications, for all encoded versions of the same source.

Indeed, as the metrics MET are obtained solely from structural data of the images provided as the source, they do not depend on the encoding process itself Therefore, the variations required in multi-stream encoding can be performed on the metrics MET without needing to completely recalculate them.

The images to be compressed are therefore analyzed only once in the main video encoder 10.

In the example described here, after this one-time analysis S1, the main video encoder 10 comprises a first determination means M2 which, in a first determination step S2, determines in accordance with the metric(s) MET of the video stream the ideal encoding structure(s) for each stream OUT1, OUT2, OUT3, and OUTN.

In the example described here and shown in FIG. 1a, the computing device 100 further comprises second determination means M3_1, M3_2, M3_3, M3_N configured to determine, in accordance with said at least one metric MET, an adaptive quantization of the video stream IN, in a second determination step S3.

As stated above, this quantization allows controlling the lossy portion of the compression and the bitrate of the output video stream compressed for the network.

The obtained metrics MET therefore follow the same path as for the source images I, and methods for compensating for variations applied to the source images are applied.

The most common variations are simple scaling; for this purpose, in the example described here, each secondary encoder 20, 30 and N comprises processing means M4_2 and M4_2′, M4_3 and M4_3′, and M4_N and M4_N′, which are configured for scaling the video stream IN and/or said at least one metric MET, during a processing step S4. This scaling allows the metric(s) MET to match the video stream IN to be encoded.

For some metrics MET such as average brightness or indication of a scene change, these variations have no impact.

However, for other variations such as variance or a set of motion vectors, it is necessary to apply a transform to the metrics MET so that they match the individual stream to be encoded.

A direct transform, meaning without using the image, sometimes does not give satisfactory results. This is the case, for example, for the set of motion vectors or the quadtree-based partitioning used in HEVC encoders.

For this reason, it may be necessary to refine the metrics MET for the images I. For this purpose, the processing means M4_2 and M4_2′, M4_3 and M4_3′, and M4_N and M4_N′, are configured for refining said at least one metric MET for at least one image I of the video stream IN during a refinement step S5.

This is generally very inexpensive in terms of computation because a good starting point can be obtained from the initial metrics.

As shown in FIGS. 1a and 1b, the images I and the metrics MET are scaled from variations that are already scaled. This is the most efficient method in terms of computation, but it should be noted that in practice in order to be usable it requires that the variations be ordered. For example, when starting with a frame rate of 25 fps (frames per second), variations at 12.5 fps and 6.25 fps impose the temporal decimation order: 6.25 fps is obtained from 12.5 fps, the opposite being impossible.

Next the encoder, meaning the main encoder 10 and the secondary encoders 20, 30, N, each comprise encoding means M5_1, M5_2, M5_3, M5_N respectively configured to encode the video stream IN according to different input parameters in order to obtain compressed video streams OUT1, OUT2, OUT3, OUTN that are independent of each other.

Thus, with the invention, the analysis of the image I is performed on the main stream, and the determination of encoding structure can be shared for all streams.

It thus becomes possible to synchronize the chunks for example on the scene changes that are common to all streams.

It is therefore possible to produce multiple compressed streams OUT1, OUT2, OUT3, OUTN from the same source video IN.

In the example described here, each output stream is a spatially decimated (reduced image size) and/or temporally decimated (reduced number of frames per second) version of the same source video, in particular in accordance with the metric(s) MET determined during a single analysis.

It is then possible, according to the invention, to derive secondary compressed streams at different rates.

This series of technical steps is controlled by a computer program PG comprising instructions adapted for executing the steps of the method described above and which is contained in a storage medium CI.

It should be noted that this description relates to a particular embodiment of the invention, but in no case does this description place any limitation on the object of the invention; rather, it is intended to eliminate any inaccuracies or misinterpretation of the following claims.

1. A method for processing a video stream (IN) that allows generating at least two compressed video streams (OUT1, OUT2, OUT3, OUTN), wherein it comprises the following steps :
an analysis step (S1) in which at least one image (I) of the video stream (IN) is analyzed in order to determine at least one metric (MET) of the video stream (IN), and
an encoding step (S6) in which, following a transformation such as, for example, a spatial and/or temporal decimation, a change of color space, and/or a deinterlacing operation, the video stream (IN) is encoded in accordance with said at least one metric (MET) so as to obtain said at least two compressed video streams (OUT1, OUT2, OUT3, OUTN).

2. The processing method according to claim 1, wherein said at least one metric (MET) determined in the analysis step (S1) consists in particular of an average brightness, an indication of a scene change, a variance, the complexity, the local and/or overall activity, a pre-grid of weighting information for blocks of images, and/or a set of motion vectors.

3. The processing method according to claim 1, wherein it comprises a first determination step (S2) during which an encoding structure for the video stream is determined in accordance with said at least one metric (MET).

4. The processing method according to claim 1, wherein it comprises a second determination step (S3) during which an adaptive quantization of the video stream is determined in accordance with said at least one metric (MET).

5. The processing method according to claim 1, wherein it comprises a processing step (S4) consisting of scaling the video stream (IN) and/or said at least one metric (MET).

6. The processing method according to claim 5, wherein the scaling is performed in such a way that it allows a change of spatiotemporal resolution and/or a change of frame rate.

7. The processing method according to claim 5, wherein it comprises a refinement step (S5) during which said at least one metric (MET) is refined for at least one image (I) of the video stream (IN).

8. A non-transmissible computer-readable storage medium comprising a computer program comprising instructions for executing the steps of the method according to claim 1, when said computer program is executed by a computer.

9. A computing device (100) for processing a video stream (IN) which allows generating at least two compressed video streams (OUT1, OUT2, OUT3, OUTN), characterized in that it comprises:
an analysis means (M1) configured for analyzing at least one image (I) of the video stream (IN) in order to determine at least one metric (MET) of said video stream (IN), and
at least first (M5_1) and second (M5_2) encoding means configured to encode, in accordance with said at least one metric (MET), said video stream previously transformed in a transformation such as, for example, a spatial and/or temporal decimation, a change of color space, and/or a deinterlacing operation on the video stream so as to obtain said at least two compressed video streams (OUT1, OUT2, OUT3, OUTN).

10. The computing device (100) according to claim 9, wherein it comprises a first determination means (M2) configured for determining, in accordance with said at least one metric (MET), an encoding structure of the video stream (IN).

11. The computing device (100) according to claim 9, wherein it comprises at least a second determination means (M3_1; M3_2; M3_3; M3_N) configured for determining, in accordance with said at least one metric (MET), an adaptive quantization of the video stream (IN).

12. The computing device (100) according to claim 9, wherein it comprises at least one processing means (M4_2, M4_2′; M4_3, M4_3′; M4_N, M4_N′) configured to allow scaling the video stream (IN) and/or said at least one metric (MET).

13. The computing device (100) according to claim 12, wherein said at least one processing means (M4_2, M42′; M4_3, M4_3′; M4_N, M4_N′) is configured to enable a change of spatiotemporal resolution of the video stream and/or a change of frame rate.

14. The computing device (100) according to claim 13, wherein said at least one processing means (M4_2, M4_2′; M4_3, M4_3′; M4_N, M4_N′) is configured for refining said at least one metric (MET) for at least one image (I) of the video stream (IN).
